(19) United States
(12) Patent Application Publication
(10) Pub. No.: US 2026/0321997 A1
(43) Pub. Date: Oct. 15, 2026

(54) BUSBAR CONNECTOR CLAMP FOR ELECTRICALLY CONNECTING BUSBAR END SECTIONS

(71) Applicant: TE Connectivity Solutions GmbH, Schaffhausen (CH)

(72) Inventors: Sundareshan MALAVALLI DASAPRAKASH, Schaffhausen (CH); Xavier ROUILLARD, Schaffhausen (CH); Quentin DELESTRE, Schaffhausen (CH); Francois JODON DE VILLEROCHE, Schaffhausen (CH); Paul MARIA JOSEPH, Schaffhausen (CH)

(21) Appl. No.: 19/646,831

(22) Filed: Apr. 14, 2026

(30) Foreign Application Priority Data
Apr. 15, 2025 (EP) 25305548.7

(51) Int. Cl. H01R 4/48; H01R 11/11

(52) U.S. Cl. CPC H01R 4/4811; H01R 4/485; H01R 4/4852; H01R 11/11

(57) ABSTRACT

A busbar connector clamp for electrically connecting an end section of a first busbar and an end section of a second busbar, wherein the first and second busbars are arranged longitudinally side-by-side, includes at least three clamp jaws comprising a first clamp jaw, a second clamp jaw and a third clamp jaw, wherein at least the first and second clamp jaws together define a first clamp mouth for inserting the end section of the first busbar along a first insertion direction, wherein at least the first and third clamp jaws together define a second clamp mouth for inserting the end section of the second busbar along a second insertion direction, and wherein at least the first clamp jaw is electrically conductive.

### CROSS REFERENCE TO RELATED APPLICATIONS

This application claims the benefit of EP Application No. 25305548.7 filed 15 Apr. 2025, the subject matter of which is herein incorporated by reference in its entirety.

### BACKGROUND OF THE INVENTION

The present invention relates to a busbar connector clamp for electrically connecting an end section of a first busbar and an end section of a second busbar. The present invention further relates to a busbar terminal comprising a plurality of such busbar connector clamps.

Busbars are critical components in high current power distribution. Two busbars may be electrically interconnected by electrically connecting their end sections using an electrical connector. However, existing electrical connectors for busbar end sections tend to be rather tall, making them unsuitable in space-constrained applications. Moreover, an electrical path created in such a connector tends to lengthen the overall electrical path between the two busbars, resulting in inefficient power transmission.

There is therefore a need for a busbar connector with a reduced height which improves busbar power transmission.

### BRIEF DESCRIPTION OF THE INVENTION

In one embodiment, an object of the present invention is to improve busbar connections in terms of installation space and electrical efficiency. This object is achieved by a busbar connector clamp for electrically connecting an end section of a first busbar and an end section of a second busbar, wherein the first and second busbars are arranged longitudinally side-by-side, the busbar connector clamp comprising: at least three clamp jaws comprising a first clamp jaw, a second clamp jaw and a third clamp jaw, wherein at least the first and second clamp jaws together define a first clamp mouth for inserting the end section of the first busbar along a first insertion direction, wherein at least the first and third clamp jaws together define a second clamp mouth for inserting the end section of the second busbar along a second insertion direction, and wherein at least the first clamp jaw is electrically conductive.

The first clamp jaw being shared by the two clamp mouths and being electrically conductive may improve electrical conduction between the two busbars. The side-by-side arrangement of the first and second busbars may mean a reduced height for the busbar connector clamp.

The above solution may be further improved by adding one or more of the following optional features. Each of these optional features is advantageous on its own and may be combined independently with any other optional feature.

In certain embodiments, the first clamp jaw, the second clamp jaw and the third clamp jaw may be in a serpentine arrangement. This may distribute mechanical stress more evenly, improving the overall stability of the busbar connector clamp under dynamic loads or vibrations.

Optionally, the first insertion direction may be opposite to the second insertion direction. This may provide greater degrees of freedom for aligning and inserting the busbar end sections.

In other embodiments, the first insertion direction may be the same as the second insertion direction. This simplifies assembly and maintenance by allowing both busbar end sections to be inserted in a single direction. The first clamp jaw, the second clamp jaw and the third clamp jaw may be in an E-shape arrangement.

In other embodiments, the first clamp jaw may comprise a first contact surface for electrically contacting the end section of the first busbar when inserted along the first insertion direction, wherein the first contact surface protrudes towards an end section of the second clamp jaw, and wherein the first contact surface protrudes perpendicularly to the first insertion direction. Additionally, or alternatively, the first clamp jaw may comprise a second contact surface for electrically contacting the end section of the second busbar when inserted along the second insertion direction, wherein the second contact surface protrudes towards an end section of the third clamp jaw, and wherein the second contact surface protrudes perpendicularly to the second insertion direction. Optionally, the first contact surface may taper towards the end section of the second clamp jaw. In other embodiments, the second contact surface may taper towards the end section of the third clamp jaw. This may provide better alignment for the first and/or second busbar end sections during insertion.

Optionally, the first contact surface may be located on a first contact pad. This may enhance the quality and consistency of the electrical connection between the first clamp jaw and the end section of the first busbar.

Optionally, the second contact surface may be located on a second contact pad. This may enhance the quality and consistency of the electrical connection between the first clamp jaw and the end section of the first busbar.

Optionally, the first and second contact surfaces of the first clamp jaw may be located on opposite sides of the first clamp jaw. This may provide better alignment for the first and second busbar end sections during insertion.

In certain embodiments, the first and second contact surfaces of the first clamp jaw may be located on a straight line, and the straight line may be slanted relative to the first and/or second insertion directions. Optionally, the straight line corresponds to a conductive path through the first clamp jaw during operation when current flows between the first and second busbars. This may reduce the overall conductive path between a point in the end section of the first busbar and a point in the end section of the second busbar, improving power transmission. In other embodiments, the midpoint of the first contact surface and the midpoint of the second contact surface may be located on the straight line.

In other embodiments, the first and second contact surfaces of the first clamp jaw may be offset relative to one another along the first and/or second insertion directions. This may improve the electrical reliability and mechanical stability of the busbar end connection.

Optionally, the first contact surface of the first clamp jaw may be offset from the second contact surface of the first clamp jaw in a direction opposite to the first insertion direction. Likewise, the second contact surface of the first clamp jaw may be offset from the first contact surface of the first clamp jaw in a direction opposite to the second insertion direction.

The first contact surface of the first clamp jaw and the end section of the second clamp jaw may together be configured to hold the end section of the first busbar, and/or the second contact surface of the first clamp jaw and the end section of the third clamp jaw may together be configured to hold the end section of the second busbar.

Optionally, the end section of the second clamp jaw may comprise a clamping section which protrudes towards the first clamp jaw, and/or the end section of the third clamp jaw may comprise a clamping section which protrudes towards the first clamp jaw. This may create a more secure and focused clamping force on the busbar end sections.

In certain embodiments, the first contact surface of the first clamp jaw and the clamping section of the end section of the second clamp jaw may be longitudinally offset along the first insertion direction, and/or the second contact surface of the first clamp jaw and the clamping section of the end section of the third clamp jaw may be longitudinally offset along the second insertion direction. This may ensure uniform clamping pressure, enhancing electrical contact and providing a more stable and reliable connection.

Optionally, at least one of the second and third clamp jaws may be electrically conductive. Herein, the first clamp jaw may have a higher electrical conductivity than the at least one of the second and third clamp jaws.

The object defined in the outset is also achieved by a busbar connector terminal comprising a plurality of the above busbar connector clamps, wherein at least two of the plurality of the busbar connector clamps are stacked in a direction perpendicular to the first and second insertion directions.

The busbar connector terminal benefits from the above-explained advantages of the busbar connector clamps.

Further, the busbar connector terminal may help to distribute electrical and mechanical stresses more evenly, improving reliability and durability under operational conditions.

Optionally, the busbar connector terminal may comprise contact lamellae formed by at least the second and third clamp jaws of the plurality of busbar connector clamps. This may provide a reliable, low-resistance contact surface for electrical conduction, improving the efficiency and consistency of the busbar end connection.

In other embodiments, each first clamp jaw of the plurality of busbar connector clamps may further comprise a third contact surface for stacking the at least two of the plurality of the busbar clamps. In particular, the third contact surface may be planar and perpendicular to the first or second insertion directions. This may ensure precise alignment of the stacked busbar connector clamps, allowing for stable and secure stacking without shifting or misalignment.

In the following, exemplary embodiments of the invention are described with reference to the drawings. The shown and described embodiments are for explanatory purposes only. The combination of features shown in the embodiments may be changed according to the foregoing description. For example, a feature which is not shown in an embodiment but described above may be added if the technical effect associated with this feature is beneficial for a particular application. Vice versa, a feature shown as part of an embodiment may be omitted as described above, if the technical effect associated with this feature is not needed in a particular application.

### BRIEF DESCRIPTION OF THE DRAWINGS

FIG. 1 is a schematic side view of a busbar connector clamp.

FIG. 2 is a schematic perspective view of the busbar connector clamp shown in FIG. 1.

FIG. 3 is a schematic side view of a busbar connector clamp with contact pads.

FIG. 4 is a schematic side view of a busbar connector clamp with clamp jaws in an S-shape arrangement and contact pads.

FIG. 5 is a schematic side view of the busbar connector clamp shown in FIG. 1-2 electrically connecting end sections of two busbars.

FIG. 6 is a schematic side view of another busbar connector clamp.

FIG. 7 is a schematic side view of the busbar connector clamp shown in FIG. 6 electrically connecting end sections of two busbars.

FIG. 8 is a schematic perspective view of a busbar connector terminal.

FIG. 9 is a schematic perspective view of the busbar connector terminal shown in FIG. 8 electrically connecting end sections of two busbars.

### DETAILED DESCRIPTION OF THE INVENTION

The present invention will now be explained in more detail with reference to the drawings. It should be noted that the drawings are not drawn to scale and that the proportions and dimensions may in reality be different and may be chosen as needed.

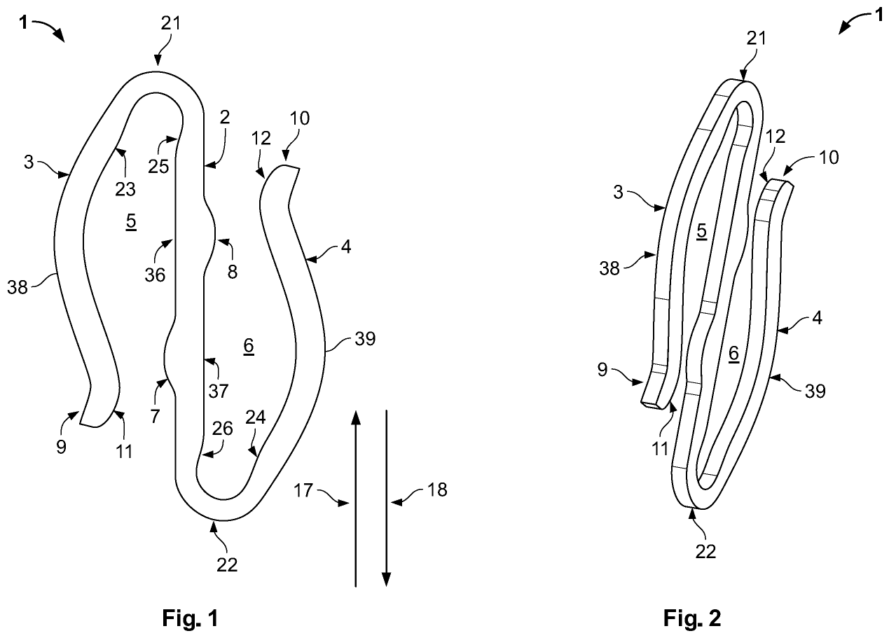

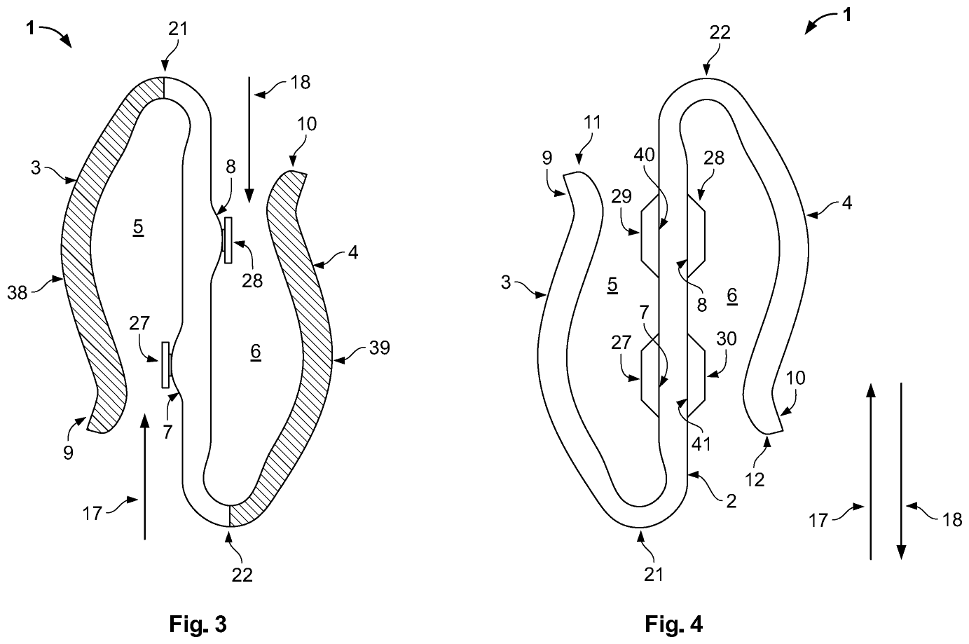

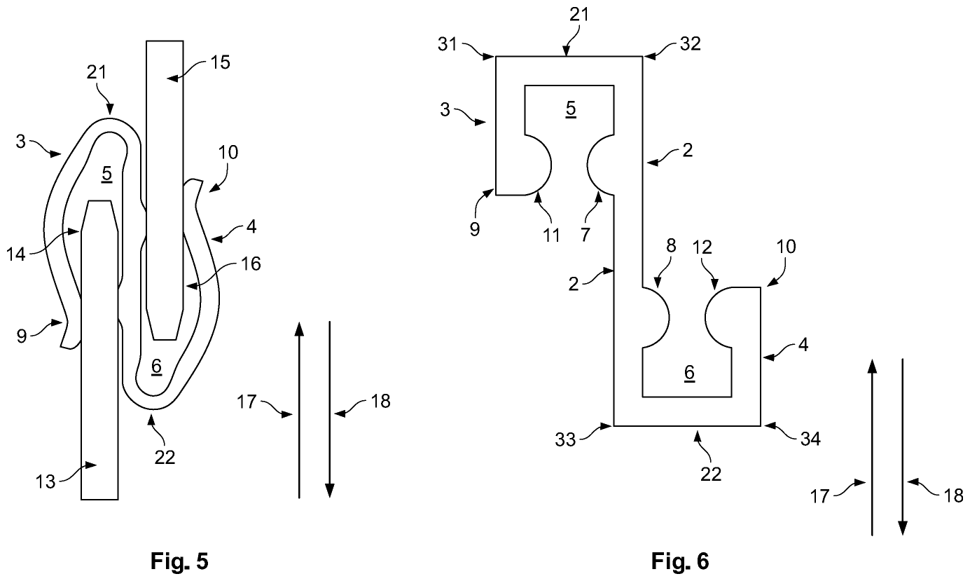

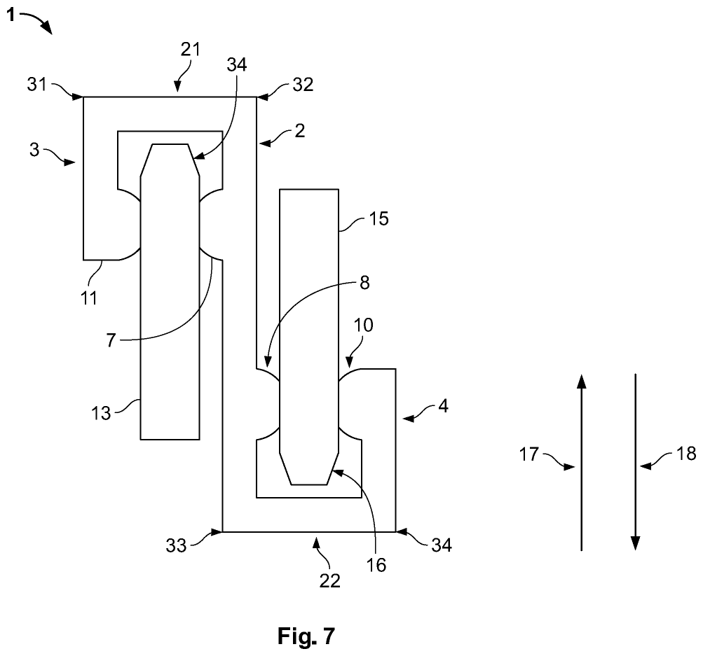

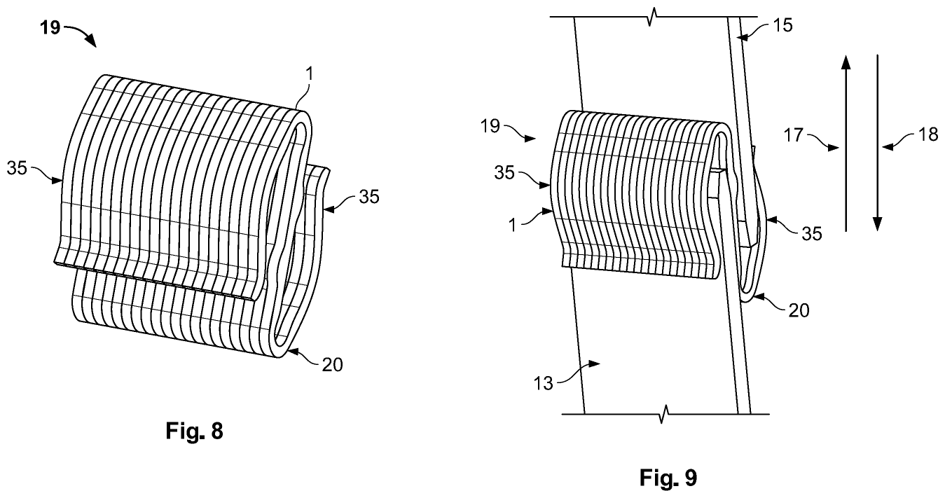

FIGS. 1 and 2 respectively show an embodiment of a busbar connector clamp 1 from two different views. FIGS. 3, 4 and 6 respectively show other embodiments of a busbar connector clamp 1. The busbar connector clamp 1 is for electrically connecting an end section 14 of a first busbar 13 and an end section 16 of a second busbar 15, the busbars 13, 15 being arranged longitudinally side-by-side. This is illustrated in FIGS. 5 and 7. The busbar connector clamp 1 has a first clamp jaw 2, a second clamp jaw 3 and a third clamp jaw 4. The first clamp jaw 2 is electrically conductive. The first and second clamp jaws 2, 3 together define a first clamp mouth 5 for inserting the end section 14 of the first busbar 13 along a first insertion direction 17. The first and third clamp jaws 2, 4 together define a second clamp mouth 6 for inserting the end section 16 of the second busbar 15 along a second insertion direction 18.

A busbar may be a conductive component used in electrical systems to distribute electrical power efficiently across various circuits. Busbars may be made from copper, aluminum, or steel. Busbars may be designed to carry high currents with minimal resistance and voltage drop. Busbars may be commonly found in switchgear, distribution boards, electrical panels, and substations.

The clamp jaws 2, 3, 4 may be manufactured by applying a series of precise fabrication processes to a base material such as a sheet metal to ensure structural integrity and functionality. These processes may involve cutting and shaping the base material using techniques like laser cutting, stamping, or forging, followed by precision machining, such as CNC milling or turning, to achieve the exact dimensions required for proper performance. The second and third clamp jaws 3, 4 may be electrically conductive. The first clamp jaw 2 may have a higher electrical conductivity than the second and third clamp jaws 3, 4, by selecting a base material for the first clamp jaw 2 that has superior conductivity properties, such as copper. On the other hand, the second and third jaws 3, 4 may be made from base materials with lower conductivity but superior mechanical properties, such as stainless steel.

The clamp mouth 5, 6 may refer to the opening or gap between the first and second clamp jaws 2, 3 or the first and third clamp jaws 2, 4. They may allow end sections of busbars to be inserted securely for holding, fastening, or connecting. The clamp mouth 5, 6 may serve as the space where the busbar end section is placed before the clamp jaws close around it to apply pressure and ensure a tight fit. The size, shape, and alignment of the clamp mouth 5, 6 may be tailored to match the specific dimensions and geometry of the busbar end section being inserted. The orientation and positioning of the clamp mouth 5, 6 may vary, allowing for insertion along different axes or directions to suit specific installation requirements. In this regard, the first insertion direction 17 may be opposite to the second insertion direction 18.

The busbar connector clamp 1 may have a first connecting section 21 mechanically connecting the first and second clamp jaws 2, 3 and a second connecting section 22 mechanically connecting the first and third clamp jaws 2, 4. As shown in FIGS. 1 to 4 and 6, the first and second connecting sections 21, 22 may be bent, curved or folded sections. As shown in FIGS. 6 and 7, the first and second connecting sections 21, 22 may be straight sections. The straight first connecting section 21 may comprise a first square edge 31 and a second square edge 32. The straight second connecting section may comprise a third square edge 33 and a fourth square edge 34.

The mechanical connection may be achieved through various methods, including integral forming, where the connecting sections 21, 22 and the clamp jaws 2, 3, 4 are produced as a single, continuous piece using stamping, bending, or extrusion. Alternatively, welding, soldering, riveting, or bolted joints may be employed to secure the connecting sections 21, 22 to the clamp jaws 2, 3, 4. Welding involves the fusion of two or more pieces of material by applying heat, often combined with pressure, to melt and join them. It creates a strong, permanent bond, making it ideal for high-strength applications where a seamless connection is required. Riveting uses mechanical fasteners (e.g., rivets) that are deformed to create a strong connection between materials. Lastly, bolted joints use threaded bolts and nuts to fasten materials together, offering a releasable and versatile connection.

The first clamp jaw 2 may have a first beveled section 25 and a second beveled section 26. They may enhance the structural integrity of the busbar connector clamp 1 by reducing stress concentrations and evenly distributing mechanical loads. These beveled sections 25, 26 may be designed to address the inherent challenges of mechanical stress during operation, particularly in electrical environments where the clamp is exposed to high forces, vibrations, or temperature fluctuations. By reducing stress concentrations, the beveled sections 25, 26 may help distribute mechanical loads more evenly across the first clamp jaw 2, which may prevent damage such as cracking, wear, or premature failure.

In particular, the beveled sections 25, 26 may create a smoother transition between surfaces, reducing the presence of sharp corners or edges that could otherwise act as stress risers. These stress risers are weak points where mechanical forces are concentrated, leading to localized deformation or material fatigue over time. The gradual curvature provided by the bevels may enhance the busbar connector clamp's resistance to such forces, promoting longevity and maintaining the integrity of the clamp's structure even under high-pressure conditions.

Additionally, the beveled sections 25, 26 may increase the rigidity of the first clamp jaw 2 by preventing unnecessary flexing or movement during clamping, which may ensure that the applied force is efficiently transmitted without compromising the uniformity of the clamping pressure. This may be crucial for maintaining a reliable and consistent connection between the busbar end sections and the busbar connector clamp 1, helping to reduce the risk of loosening, overheating, or electrical resistance due to poor contact.

The first clamp jaw 2 may have a first flat surface 36 and a second flat surface 37. The first flat surface 36 may face the second clamp jaw 3 and the second flat surface 37 may face the third clamp jaw 4. They may ensure proper alignment and contact between the clamp jaws, helping to maintain a precise and uniform clamping force across the busbar end sections. The flat surfaces 36, 37 may contribute to the clamp's ability to distribute mechanical loads evenly. Because the surfaces are parallel and smooth, they reduce the risk of creating high-pressure points, which may otherwise cause uneven clamping or damage to the busbar, particularly under high forces or vibrations. This even distribution of pressure is crucial for maintaining a stable, secure connection, as it minimizes the likelihood of loose contacts, electrical resistance, or heat build-up. In addition to enhancing the uniformity of the clamping force, the flat surfaces 36, 37 may also improve the rigidity and structural integrity of the first clamp jaw 2. The precise positioning of these surfaces 36, 37 may ensure that forces are transmitted consistently along the entire length of the clamp jaw, preventing unwanted flexing or shifting. This added rigidity may help the clamp maintain its form and function over time, even under repeated use or fluctuating external conditions.

The use of flat surfaces also may simplify the manufacturing and assembly process. Flat surfaces are easier to produce with high precision, reducing the chances of defects or inconsistencies that could affect the clamp's performance. Furthermore, flat surfaces make assembly more straightforward, as they provide predictable, stable contact points that align easily with other components of the clamp. This consistency not only improves the manufacturing process but also ensures that each unit operates reliably and with minimal maintenance requirements. By integrating these flat surfaces, the first clamp jaw 2 enhances the overall performance, durability, and ease of production for the busbar connector clamp, contributing to both its mechanical strength and its electrical reliability in demanding applications.

A first raised section 23 may be comprised by the second clamp jaw 3 and a second raised section 24 may be comprised by the third clamp jaw 4. The first and second raised sections 23, 24 may serve several critical purposes, with one of their primary functions being the improvement of the alignment between the clamp jaws 2, 3, 4 during assembly. By providing localized elevation at specific points, the raised sections help ensure that the clamp jaws are properly positioned and aligned, minimizing the risk of misalignment during the clamping process. This precise alignment may be crucial for achieving secure and effective clamping, as any misalignment could result in uneven pressure distribution or compromised contact with the busbar end section.

In addition to improving alignment, the raised sections 23, 24 may also play a key role in enhancing the distribution of clamping forces across the clamp jaws. By raising the clamp jaws 3, 4 at specific points, these raised sections 23, 24 may contribute to a more even and efficient transfer of mechanical loads, ensuring that the applied forces are spread across the entire surface area of the clamp jaws. This may help prevent excessive localized deformation that could occur if the clamping force were concentrated in a small area, thereby reducing the potential for material fatigue or failure over time.

Furthermore, the raised sections 23, 24 may contribute to the prevention of misalignment under load. As the clamp 1 is tightened and the clamping force is applied, these raised sections 23, 24 may help keep the clamp jaws aligned and prevent any shifting or slipping that could occur due to external forces, vibrations, or thermal expansion. This may result in more consistent pressure being applied across the busbar end sections, ensuring that the clamp maintains its grip and that the electrical connection remains secure and stable.

Ultimately, the raised sections 23, 24 may contribute to the overall stability, reliability, and long-term durability of the busbar connector clamp 1. By improving alignment, enhancing force distribution, and preventing misalignment under load, these features help ensure that the clamp continues to perform effectively over time, even under demanding conditions. This design not only improves the mechanical integrity of the clamp but may also ensure that the electrical contact remains consistent and reliable throughout its lifetime.

A first curved section 38 may be comprised by the second clamp jaw 3 and a second curved section 39 may be comprised by the third clamp jaw 4. The first and second curved sections 38, 39 may form part of the surrounding structure of the busbar connector clamp 1, contributing to its overall shape and functionality, and may help in guiding or positioning the second and third clamp jaws 3, 4 for effective engagement and clamping of the busbar end sections 14, 16. These curved sections may be integral components of the surrounding structure of the busbar connector clamp 1, playing a significant role in both the overall shape and functionality of the clamp. The primary function of the first and second curved sections 38, 39 may be to guide and position the second and third clamp jaws 3, 4 relative to each other, ensuring that they engage with the busbar end sections 14, 16 effectively and securely. The smooth curvature of these sections may help facilitate an efficient and controlled movement of the clamp jaws as they approach one another. This controlled movement may be essential for maintaining consistent alignment, ensuring that the clamp jaws fit together precisely without any risk of skewing or misalignment during the clamping process.

Moreover, these curved sections 38, 39 may be critical for the accurate and uniform application of clamping force. By guiding the clamp jaws into the correct position, the curved sections 38, 39 may help ensure that the force exerted by the clamp is distributed evenly across the entire contact area between the clamp jaws and the busbar end sections. This even distribution of force may be crucial for preventing concentrated pressure points, which may otherwise lead to deformation, excessive wear, or potentially damaging electrical resistance. The ability to apply an even and consistent clamping force also helps in ensuring that the busbar remains securely in place, contributing to a stable and reliable electrical connection.

In addition to guiding and aligning the clamp jaws, the curved sections 38, 39 may also play a role in distributing mechanical stresses and enhancing the structural integrity of the clamp. By shaping the clamp jaws with curves at strategic points, the overall rigidity and stability of the clamp may be improved, ensuring that the clamp remains firmly in position during operation without undue flexing or shifting. The curvature of the sections also may help in minimizing potential weak points that could otherwise lead to fatigue or material failure over time, especially under repeated mechanical or thermal stress. The curved sections may further contribute to the ease of assembly and alignment during the manufacturing and installation processes. The smooth, predictable curves may ensure that the clamp jaws fit together with precision, making the assembly process more straightforward and reducing the likelihood of errors or misalignments that could affect the functionality of the busbar connector clamp 1.

The clamp jaws 2, 3, 4 may be arranged in various shapes and configurations, offering flexibility in design to accommodate different functional and manufacturing requirements. These shapes may include smooth, flowing curves, sharp angular transitions, or a combination of both. The arrangement of the clamp jaws 2, 3, 4 may be tailored to optimize performance, enhance structural integrity, or achieve a specific aesthetic. Depending on the application, the clamp jaws 2, 3, 4 may follow a continuous, curved path, an angular pattern, or a more complex geometric configuration. This versatility allows for a wide range of possible designs to suit various engineering and operational needs.

The first clamp jaw 2, the second clamp jaw 3 and the third clamp jaw 4 may be in a serpentine arrangement. This may be achieved via the above-mentioned manufacturing techniques. In particular, the clamp jaws 2, 3, 4 may be shaped to follow a meandering or zig-zag path. A meandering path may refer to a continuous, winding shape that curves back and forth in a smooth, serpentine manner. It may exhibit gentle, sweeping curves that do not follow a straight line, often resembling the natural flow of a river or a winding road. With respect to the clamp jaws 2, 3, 4, a meandering path may involve gradual, flowing curves, with no sharp angles. A zig-zag path, on the other hand, may involve a series of sharp, angular turns, creating a pattern that alternates between acute angles in opposing directions. It may be characterized by a more abrupt, angular shape compared to the meandering path. The zig-zag path may look like a series of connected “U” or “V” shapes. For the clamp jaws 2, 3, 4, a zig-zag path may result in more defined, angular transitions between each clamp jaw 2, 3, 4.

The serpentine arrangement may include an S-shape arrangement and a meandering grid arrangement. FIG. 4 is a schematic side view of a busbar connector clamp 1 in which the first clamp jaw 2, the second clamp jaw 3 and the third clamp jaw 4 are in an S-shape arrangement. An S-shape arrangement refers to a configuration where the elements follow a continuous, smooth curve that resembles the alphabetical letter “S.” In particular, the first clamp jaw 2, second clamp jaw 3, and third clamp jaw 4 may be arranged in a pattern where each clamp jaw 2, 3, 4 follows the shape of an “S” from one end to the other. The S-shape may involve two distinct curves: one curve that flows in one direction, followed by a reversal of direction that creates a symmetrical pattern. This design may allow the clamp jaws 2, 3, 4 to follow a gentle, continuous curve, with the jaws positioned along the curves of the “S” shape.

FIG. 6 is a schematic perspective view of a busbar connector clamp 1 in which the first clamp jaw 2, the second clamp jaw 3 and the third clamp jaw 4 are in a meandering grid arrangement. As shown in FIG. 7, this busbar connector clamp 1 may electrically connect an end section 14 of a first busbar 13 and an end section 16 of a second busbar 15, the busbars 13, 15 being arranged longitudinally side-by-side. A meandering grid arrangement may refer to a pattern where the first clamp jaw 2, second clamp jaw 3, and third clamp jaw 4 follow a grid-like structure while maintaining a meandering or winding path. This may mean that the clamp jaws 2, 3, 4 may be positioned in a grid formation, but instead of following straight, rigid lines, they follow a path that alternates between gentle curves or zigzags, creating a more fluid, continuous, and flexible arrangement. The meandering grid may involve the clamp jaws 2, 3, 4 being arranged in rows and columns, but each jaw 2, 3, 4 may be shaped to curve slightly as it moves horizontally or vertically, so the overall pattern looks like a grid that has been slightly warped or bent.

The first clamp jaw 2 may have a first contact surface 7 for electrically contacting the end section 14 of the first busbar 13 when inserted along the first insertion direction 17. The first clamp jaw 2 may have a second contact surface 8 for electrically contacting the end section 16 of the second busbar 15 when inserted along the second insertion direction 18. The contact surface 7, 8 may refer to the specific area or region of the first clamp jaw 2 that directly interacts with the end sections of the busbars to establish a physical or electrical connection. In the context of electrical connections, the contact surface 7, 8 may be particularly important as it may define the location through which electrical current flows between two conductive parts. For example, the first clamp jaw 2 may have a first contact surface 7 that is carefully designed to make direct contact with the end section 14 of the first busbar 13 when it is inserted along the first insertion direction 17. Similarly, the second contact surface 8 of the first clamp jaw may be positioned to engage with the end section 16 of the second busbar 15 when inserted along the second insertion direction 18, facilitating a secure electrical contact for the second busbar 15. The contact surface 7, 8 may be shaped to maximize the surface area in contact with the busbar end sections 14, 16, ensuring efficient electrical transfer. Specialized coatings or treatments may be applied to the contact surface 7, 8 to improve electrical conductivity, reduce oxidation, or protect against wear. For example, the contact surface may be plated with materials like copper or silver to reduce electrical resistance and ensure consistent performance over time. Additionally, the contact surfaces 7, 8 may comprise textured patterns or raised areas to improve the physical grip on the busbar end section 14, 16.

FIG. 3 is identical to FIG. 1 except for the hatching which schematically indicates the spatial extent the clamp jaws 2, 3, 4 may assume as well as the presence of first and second contact pads 27, 28. The first contact surface 7 may be located on a first contact pad 27. This may enhance the quality and consistency of the electrical connection between the first clamp jaw 2 and the end section 14 of the first busbar 13. Similarly, the second contact surface may be located on a second contact pad 28. This may enhance the quality and consistency of the electrical connection between the first clamp jaw 2 and the end section 16 of the second busbar 15.

The incorporation of the first and second contact pads 27 and 28 may allow for a more reliable and durable connection, improving both the mechanical and electrical performance of the clamp. The contact pads 27, 28 may serve to optimize the alignment between the clamp jaws and the busbar end sections, ensuring clamping force is applied uniformly and without introducing additional electrical resistance.

FIG. 4 shows a busbar connector clamp 1 with an S-shape arrangement. The first contact surface 7 may be located on a first contact pad 27. The second contact surface 8 may be located on a second contact pad 28. A fourth contact surface 40 of the first clamp jaw 2 may be located on a third contact pad 29. A fifth contact surface 41 of the first clamp jaw may be located on a fourth contact pad 30. The first and fifth contact surfaces 7, 41 may be longitudinally aligned. The second and fourth contact surfaces 28, 40 may be longitudinally aligned. These contact pads may play a crucial role in facilitating the electrical connection between the first clamp jaw 2 and the busbar end sections. By providing a stable and consistent platform for the contact surfaces, the contact pads may ensure that the electrical interface remains reliable over time, minimizing resistance and preventing issues such as overheating or contact degradation.

Additionally, the fourth contact surface 40 of the first clamp jaw 2 is located on a third contact pad 29, while the fifth contact surface 41 is positioned on a fourth contact pad 30. These additional contact pads further enhance the electrical connection, and may ensure that the clamping force is distributed evenly across the busbar. The contact pads 29 and 30 may not only contribute to the overall stability of the clamp, but they may also play a key role in preventing localized pressure points that could increase resistance or cause damage to the busbar material over time.

The contact pads 27, 28, 29, and 30 may be integral in ensuring the clamp performs optimally, as they provide the necessary surfaces for a consistent electrical connection. Their precise placement and alignment with the corresponding contact surfaces 7, 8, 40, and 41 may allow for an even distribution of clamping forces, which prevents any misalignment or distortion that could affect the quality of the electrical contact. The longitudinal alignment of the first and fifth contact surfaces 7, 41, as well as the second and fourth contact surfaces 28, 40, may further enhance the uniformity of the clamping force and may improve the overall performance of the busbar connector clamp 1.

The first contact surface 7 may protrude towards an end section 9 of the second clamp jaw 3. The second contact surface 8 may protrude towards an end section 10 of the third clamp jaw 4. The first contact surface 7 may protrude perpendicularly to the first insertion direction 17. The second contact surface 8 may protrude perpendicularly to the second insertion direction 18. The first and second contact surfaces 7, 8 of the first clamp jaw 2 may be located on opposite sides of the first clamp jaw 2. The protrusion may refer to the first contact surface 7 and second contact surface 8 extending or jutting outward from the surface of the first clamp jaw 2, beyond its remaining boundary or plane. This outward extension may enhance the interaction between the clamp jaw and the busbar end sections, improving the mechanical and electrical contact. In particular, the first contact surface 7 of the first clamp jaw 2 and the end section 9 of the second clamp jaw 3 may together be configured to hold the end section 14 of the first busbar 13. Similarly, the second contact surface 8 of the first clamp jaw 2 and the end section 10 of the third clamp jaw 4 may together be configured to hold the end section 16 of the second busbar 15.

The end section 9 of the second clamp jaw 3 may have a clamping section 11 which protrudes towards the first clamp jaw 2. Similarly, the end section 10 of the third clamp jaw 4 may have a clamping section 12 which protrudes towards the first clamp jaw 2. The clamping section 11, 12 may refer to a specific portion of the second and third clamp jaws designed to apply pressure or force to securely hold the busbar end sections. The clamping section 11, 12 may be shaped or formed to engage with the busbar end section in a way that ensures a stable and firm grip. The shape and dimensions of the clamping sections 11, 12 may vary depending on the design and the material of the busbar end section being clamped. The protrusion of these sections may be important as it may allow for a secure and controlled clamping action, enhancing the mechanical stability and ensuring that the object is held firmly, even under conditions of vibration or other dynamic forces.

In this regard, FIGS. 1 to 3 and 6 show the clamping sections 11, 12 curving away from the first clamp jaw 2. This curvature may help distribute the clamping force over a wider surface area of the busbar, potentially reducing the risk of localized stress or damage. It may also allow for a smoother, more controlled insertion process, as the busbar can be gently guided into place with less risk of misalignment or distortion. This may be beneficial in applications where the busbar is delicate or where an even, less aggressive force is needed to maintain the connection without damaging the busbar. On the other hand, FIGS. 4, 5 and 7 show the clamping sections 11, 12 neither curving away nor towards the first clamp jaw 2. This may allow the busbar connector clamp 1 to apply uniform pressure along the length of the clamping sections 11, 12. This may provide a balanced application of force. It may offer a neutral holding action, which may be useful for applications where neither excessive grip nor gentle holding is required.

The first and second contact surfaces 7, 8 of the first clamp jaw 2 may be longitudinally offset along the first and/or second insertion directions 17, 18. The first contact surface 7 of the first clamp jaw 2 may be offset from the second contact surface 8 of the first clamp jaw 2 in a direction opposite to the first insertion direction 17. The second contact surface 8 of the first clamp jaw 2 may be offset from the first contact surface 7 of the first clamp jaw 2 in a direction opposite to the second insertion direction 18. The offset may refer to the deliberate shifting or displacement of the first contact surface 7 and second contact surface 8 of the first clamp jaw 2 along the first and second insertion directions 17 and 18. This may mean that the two contact surfaces are not positioned in a perfectly aligned, overlapping or parallel arrangement but are shifted relative to each other in a way that enhances the functionality of the busbar connector clamp 1.

In particular, the first contact surface 7 may be offset from the second contact surface 8 in a direction opposite to the first insertion direction 17. This may mean that as the busbar end section 14 is inserted along the first insertion direction, the first contact surface 7 may extend slightly ahead or behind the second contact surface 8, creating a staggered alignment. Similarly, the second contact surface 8 may be offset from the first contact surface 7 in a direction opposite to the second insertion direction 18. This may result in the second contact surface 8 being shifted relative to the first contact surface 7 along the axis of the second insertion direction 18.

The first contact surface 7 of the first clamp jaw 2 and the clamping section 11 of the end section 9 of the second clamp jaw 3 may be longitudinally offset along the first insertion direction 17. The second contact surface 8 of the first clamp jaw 2 and the clamping section 12 of the end section 10 of the third clamp jaw 4 may be longitudinally offset along the second insertion direction 18.

Instead of being aligned directly along the same line, these components are designed to be offset, meaning that the first contact surface 7 and the clamping section 11, as well as the second contact surface 8 and clamping section 12, are positioned at slightly different points along the insertion directions of the busbar end sections. This may allow for a more controlled and progressive engagement between the clamp jaws and the busbars as they are inserted.

The progressive clamping action may ensure that pressure is applied gradually, avoiding concentrated force peaks at specific points and reducing the likelihood of misalignment or uneven pressure distribution. This displacement ensures a more secure, stable, and uniform interaction between the clamp jaws and the busbars, contributing to a stronger, more reliable electrical connection. Additionally, this configuration helps to minimize the risk of stress concentrations, wear, or damage to the busbars during clamping, ensuring long-term durability and consistent performance even under dynamic forces or vibrations.

FIG. 9 illustrates a busbar terminal 19 made up of the above busbar connector clamps 1. FIG. 10 illustrates the busbar connector terminal 19 of FIG. 9 electrically connecting end sections 14, 16 of two bars 13, 14. The busbar connector clamps 1 are stacked in a direction perpendicular to the first and second insertion directions 17, 18. The stacking of the busbar connector clamps 1 in a direction perpendicular to the first and second insertion directions 17 and 18 may be achieved by configuring the busbar connector clamps 1 in a multi-level arrangement, either vertically or horizontally, relative to the busbar insertion directions 17, 18.

In a vertical stack, each busbar connector clamp 1 may be positioned one above the other, with the clamp jaws oriented to clamp the busbars inserted along the insertion directions 17 and 18. Each busbar connector clamp 1 may be secured using mounting brackets, bolts, or a frame, or housing ensuring that each busbar connector clamp 1 is aligned and fixed in place while allowing for effective clamping and secure contact between the busbars and the clamp jaws.

In a horizontal stack, the clamps 1 may be positioned side by side, with each busbar connector clamp 1 oriented to secure busbars in parallel with the stacking direction, and each busbar connector clamp 1 may independently secure a busbar or work in tandem with others to clamp multiple busbars in a unified system.

The busbar terminal 19 may have contact lamellae formed by at least the second and third clamp jaws 3, 4 of the plurality of busbar connector clamps 1. The contact lamellae may refer to thin, flexible metallic strips or layers that are formed by at least the second and third clamp jaws 3, 4 of the busbar connector clamps 1. These lamellae may serve as the primary conductive surfaces that come into direct contact with the end sections of the busbars, providing an electrical connection between the busbar connector clamps 1 and the busbars.

The lamellae may be designed to maintain a high level of conductivity while offering the flexibility necessary to accommodate slight misalignments or variations in the busbar's positioning. The second and third clamp jaws 3, 4 may have their inner surfaces shaped or bent to form these lamellae, ensuring that they 3, 4 maintain consistent pressure against the busbar end section 14, 16 surfaces. The flexibility of the lamellae ensures that they can conform to the shape of the busbar end sections 14, 16, allowing for a secure, low-resistance electrical contact even when the busbar terminal 19 experiences slight movements or vibrations.

Each first clamp jaw 2 of the plurality of busbar connector clamps 1 may have a third contact surface 20 for stacking at least two of the plurality of the busbar connector clamps 1, the third contact surface 20 being planar and perpendicular to the first or second insertion directions 17, 18. The third contact surface 20 may provide a flat, stable interface for the stacking of multiple clamps 1 within the busbar terminal 19. Positioned perpendicular to the first and second insertion directions 17 and 18, this planar surface 20 enables the clamps to be stacked precisely along a vertical or horizontal axis, ensuring uniform alignment and preventing any rotational or lateral displacement between the stacked busbar connector clamps 1. Its primary role may be to create a consistent, stable platform for the first clamp jaw of each clamp, facilitating modular assembly of the busbar terminal 19 while maintaining the functional integrity of each busbar connector clamp 1 in the stack.

The perpendicular orientation of the third contact surface 20 may ensure that the individual busbar connector clamps 1 do not interfere with the insertion or clamping mechanisms, thereby optimizing the spacing and arrangement of the busbar connector clamps 1 in relation to the busbars. This surface 20 may also help distribute mechanical loads across the stack, ensuring the busbar connector clamps 1 remain securely in place under the pressure exerted during operation, and it may ensure reliable electrical connections are maintained by preventing misalignment that could compromise contact integrity. Additionally, the planar design may aid in precision stacking, allowing for straightforward assembly and disassembly of the busbar connector clamps 1 without risk of mispositioning.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A busbar connector clamp for electrically connecting an end section of a first busbar and an end section of a second busbar, wherein the first and second busbars are arranged longitudinally side-by-side, the busbar connector clamp comprising:
at least three clamp jaws comprising a first clamp jaw, a second clamp jaw and a third clamp jaw, wherein at least the first and second clamp jaws together define a first clamp mouth for inserting the end section of the first busbar along a first insertion direction,
wherein at least the first and third clamp jaws together define a second clamp mouth for inserting the end section of the second busbar along a second insertion direction, and
wherein at least the first clamp jaw is electrically conductive.

2. The busbar connector clamp according to claim 1, wherein the first clamp jaw, the second clamp jaw and the third clamp jaw are in a serpentine arrangement.

3. The busbar connector clamp according to claim 1, wherein the first insertion direction is opposite to the second insertion direction.

4. The busbar connector clamp according to claim 1, wherein the first clamp jaw comprises:
a first contact surface for electrically contacting the end section of the first busbar when inserted along the first insertion direction, wherein the first contact surface protrudes towards an end section of the second clamp jaw, and
wherein the first contact surface protrudes perpendicularly to the first insertion direction; and/or
a second contact surface for electrically contacting the end section of the second busbar when inserted along the second insertion direction, wherein the second contact surface protrudes towards an end section of the third clamp jaw, and
wherein the second contact surface protrudes perpendicularly to the second insertion direction.

5. The busbar connector clamp according to claim 4, wherein the first and second contact surfaces of the first clamp jaw are located on opposite sides of the first clamp jaw.

6. The busbar connector clamp according to claim 4, wherein the first and second contact surfaces of the first clamp jaw are located a straight line, and
wherein the straight line is slanted relative to the first and/or second insertion directions.

7. The busbar connector clamp according to claim 4, wherein the first and second contact surfaces of the first clamp jaw are offset relative to one another along the first and/or second insertion directions.

8. The busbar connector clamp according to claim 4, wherein the first contact surface of the first clamp jaw is offset from the second contact surface of the first clamp jaw in a direction opposite to the first insertion direction, and
wherein the second contact surface of the first clamp jaw is offset from the first contact surface of the first clamp jaw in a direction opposite to the second insertion direction.

9. The busbar connector clamp according to claim 4, wherein the first contact surface of the first clamp jaw and the end section of the second clamp jaw are together configured to hold the end section of the first busbar, and/or
wherein the second contact surface of the first clamp jaw and the end section of the third clamp jaw are together configured to hold the end section of the second busbar.

10. The busbar connector clamp according to claim 4, wherein the end section of the second clamp jaw comprises a clamping section which protrudes towards the first clamp jaw, and/or
wherein the end section of the third clamp jaw comprises a clamping section which protrudes towards the first clamp jaw.

11. The busbar connector clamp according claim 10, wherein the first contact surface of the first clamp jaw and the clamping section of the end section of the second clamp jaw are longitudinally offset along the first insertion direction, and/or
wherein the second contact surface of the first clamp jaw and the clamping section of the end section of the third clamp jaw are longitudinally offset along the second insertion direction.

12. The busbar connector clamp according to claim 1, wherein at least one of the second and third clamp jaws is electrically conductive, and
wherein the first clamp jaw has a higher electrical conductivity than the at least one of the second and third clamp jaws.

13. A busbar connector terminal comprising:
a plurality of busbar connector clamps for electrically connecting an end section of a first busbar and an end section of a second busbar, wherein the first and second busbars are arranged longitudinally side-by-side, each busbar connector clamp including at least three clamp jaws comprising a first clamp jaw, a second clamp jaw and a third clamp jaw, wherein at least the first and second clamp jaws together define a first clamp mouth for inserting the end section of the first busbar along a first insertion direction, wherein at least the first and third clamp jaws together define a second clamp mouth for inserting the end section of the second busbar along a second insertion direction, and wherein at least the first clamp jaw is electrically conductive;
wherein at least two of the plurality of the busbar connector clamps are stacked in a direction perpendicular to the first and second insertion directions.

14. The busbar connector terminal according claim 13, comprising:
contact lamellae formed by at least the second and third clamp jaws of the plurality of busbar connector clamps.

15. The busbar connector terminal according to claim 13, wherein each first clamp jaw of the plurality of busbar connector clamps further comprises:
a third contact surface for stacking the at least two of the plurality of the busbar connector clamps, wherein the third contact surface is planar and perpendicular to the first or second insertion directions.

16. The busbar connector terminal according to claim 13, wherein the first clamp jaw, the second clamp jaw and the third clamp jaw are in a serpentine arrangement.

17. The busbar connector terminal according to claim 13, wherein the first insertion direction is opposite to the second insertion direction.

18. The busbar connector terminal according to claim 13, wherein the first clamp jaw comprises:
a first contact surface for electrically contacting the end section of the first busbar when inserted along the first insertion direction, wherein the first contact surface protrudes towards an end section of the second clamp jaw, and
wherein the first contact surface protrudes perpendicularly to the first insertion direction; and/or
a second contact surface for electrically contacting the end section of the second busbar when inserted along the second insertion direction, wherein the second contact surface protrudes towards an end section of the third clamp jaw, and
wherein the second contact surface protrudes perpendicularly to the second insertion direction.

19. The busbar connector terminal according to claim 18, wherein the first and second contact surfaces of the first clamp jaw are located on opposite sides of the first clamp jaw.

20. The busbar connector terminal according to claim 18, wherein the first and second contact surfaces of the first clamp jaw are located a straight line, and
wherein the straight line is slanted relative to the first and/or second insertion directions.
